(19) United States
(12) Patent Application Publication
(10) Pub. No.: US 2025/0301365 A1
(43) Pub. Date: Sep. 25, 2025

(54) COMMUNICATION APPARATUS, COMMUNICATION METHOD, AND STORAGE MEDIUM

(71) Applicant: NEC Corporation, Tokyo (JP)

(72) Inventors: Takeshi KATO, Tokyo (JP); Yohei HASEGAWA, Tokyo (JP)

(73) Assignee: NEC Corporation, Tokyo (JP)

(21) Appl. No.: 19/078,408

(22) Filed: Mar. 13, 2025

(30) Foreign Application Priority Data
Mar. 22, 2024 (JP) 2024-047117

(51) Int. Cl. H04W 28/02; H04W 24/10; H04W 40/12

(52) U.S. Cl. CPC H04W 28/0236; H04W 24/10; H04W 40/12

(57) ABSTRACT

To provide a communication apparatus capable of inferring the link state of a communication path and suitably reacting to the link state. The communication apparatus includes at least one processor. The at least one processor carries out: a process of detecting an error by subjecting a signal received by communication to signal processing; a process of inferring a link state of a communication path based at least on duration of the error; and a process of providing notification of information related to the link state.

This Nonprovisional application claims priority under 35 U.S.C. § 119 on Patent Application No. 2024-047117 filed in Japan on Mar. 22, 2024, the entire contents of which are hereby incorporated by reference.

### TECHNICAL FIELD

The present disclosure relates to a communication apparatus, a communication method, and a storage medium.

### BACKGROUND ART

Recently, free space optical communication with use of light as a transmission medium has attracted attention. Such free space optical communication is susceptible to external disturbances, resulting in situations such as poor communication quality caused by the external disturbances. An example of techniques related thereto may be an invention disclosed in Patent Literature 1 described below.

The following patent literature discloses a communication system that: infers the states of a plurality of components based on one or more measurements received and indications received; if it is determined that a received electric energy is likely to be less than the minimum received electric power within a predetermined time interval based on the received indications and the inferred states of the plurality of components, selects an adjustment technique from among multiple adjustment techniques for adjusting the data rate of an outbound signal; and adjusts a predetermined component of the communication system by using the selected adjustment technique, to alter the data rate of the outbound signal.

### CITATION LIST

### Patent Literature

### [Patent Literature 1]

Japanese Translation of PCT International Application, Tokuhyo, No. 2022-508332

### SUMMARY OF INVENTION

### Technical Problem

There have been problems in the conventional scheme in that if a failure with a high fading frequency is determined to be linkdown, the line linkdown time will be increased, or flapping will occur, resulting in an unstable network.

Further, the Patent Literature 1 employs the following method. The method is such that if it is determined that the received electric energy is likely to be less than the minimum received electric power within a predetermined time interval, an adjustment technique is selected from among the multiple adjustment techniques for adjusting the data rate of the outbound signal. However, methods such as inferring link states of communication paths and reacting thereto have not been adopted.

The present disclosure has been made in view of these problems, and an example object thereof is to provide a technique capable of inferring the link state of a communication path and suitably reacting to the link state.

### Solution to Problem

A communication apparatus in accordance with an example aspect of the present disclosure includes at least one processor, the at least one processor carrying out: a process of detecting an error by subjecting a signal received by communication to signal processing; a process of inferring a link state of a communication path based at least on duration of the error; and a process of providing notification of information related to the link state.

A communication method in accordance with an example aspect of the present disclosure includes: detecting an error by subjecting a signal received by communication to signal processing; inferring a link state of a communication path based at least on duration of the error; and providing notification of information related to the link state.

A program stored in a non-transitory storage medium in accordance with an example aspect of the present disclosure, causes a computer to carry out: a process of detecting an error by subjecting a signal received by communication to signal processing; a process of inferring a link state of a communication path based at least on duration of the error; and a process of providing notification of information related to the link state.

### Advantageous Effects of Invention

According to an example aspect of the present disclosure, achieved is an example advantage of being capable of inferring the link state of a communication path and suitably reacting to the link state.

### BRIEF DESCRIPTION OF DRAWINGS

FIG. 1 is a block diagram illustrating an example of the configuration of a communication apparatus in accordance with the present disclosure.

FIG. 2 is a diagram for describing an inference method of the link state.

FIG. 3 is a flowchart for describing process procedures of the communication apparatus in accordance with the present disclosure.

FIG. 4 is a block diagram illustrating an example of the configuration of a communication apparatus in accordance with the present disclosure.

FIG. 5 is a diagram for describing an inference method of the link state.

FIG. 6 is a flowchart for describing process procedures of an inference section.

FIG. 7 is a diagram illustrating the priorities of link states.

FIG. 8 is a graph for describing processes of the inference section.

FIG. 9 is a table illustrating correspondence between link states and application types.

FIG. 10 is a diagram for describing switching of communication paths.

FIG. 11 is a block diagram illustrating the configuration of a computer that functions as the communication apparatus in accordance with the present disclosure.

### EXAMPLE EMBODIMENTS

Example embodiments of the present invention will be described below by way of example. It should be noted that the present invention is not limited to the example embodiments described below, but may be altered in various ways by a skilled person within the scope of the claims. For example, any example embodiment derived by appropriately combining technical means employed in the example embodiments described below can be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment, which is an example of an embodiment of the present invention, will be described in detail with reference to the drawings. The present example embodiment is a basic form of each example embodiment discussed later. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means indicated in the drawings referred to for discussing the present example embodiment can be employed also in another example embodiment included in the present disclosure, provided that no particular technical problems occur.

### (Configuration of Communication Apparatus 1)

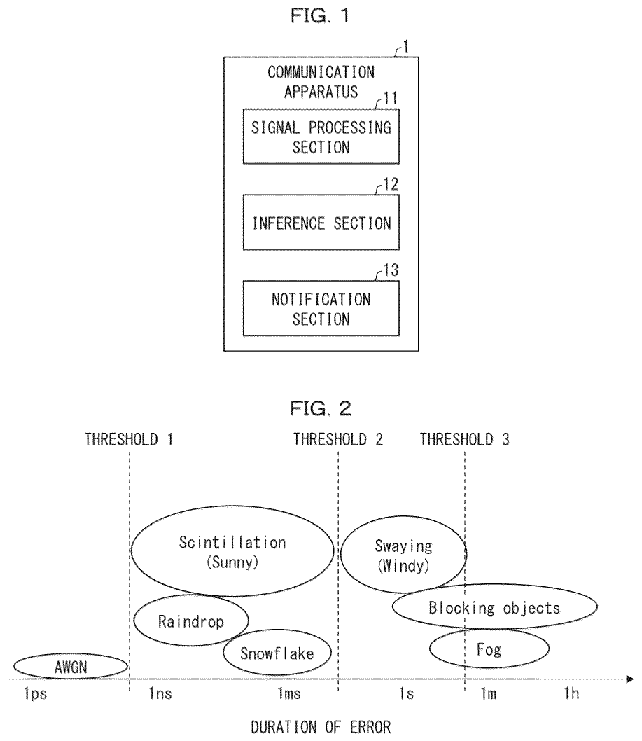

The following description will discuss the configuration of a communication apparatus 1 with reference to FIG. 1. FIG. 1 is a block diagram illustrating an example of the configuration of the communication apparatus 1. The communication apparatus 1 is applicable to an apparatus that performs free space optical communication, but is also applicable to, for example, an apparatus that utilizes radio waves or the like. The communication apparatus 1 includes a signal processing section 11, an inference section 12, and a notification section 13 as illustrated in FIG. 1.

The signal processing section 11 is configured to detect an error by subjecting a signal received by communication to signal processing. For example, in a case where communication is performed by free space optical communication, the signal processing section 11 subjects an optical signal received via an optical sensor or the like to signal processing. For example, although the signal processing section 11 performs error detection and error correction of received data by using forward error correction (FEC) or the like, packet loss may occur if an error cannot be corrected by FEC. The signal processing section 11 detects, as an error, received data which cannot be corrected by the error correction.

The inference section 12 is configured to infer the link state of the communication path based at least on the duration of the error. For example, the inference section 12 may determine which state of a plurality of states the link state is, based on the duration of the error.

FIG. 2 is a diagram for describing an inference method of the link state. In FIG. 2, the horizontal axis represents the duration of error, and thresholds 1 to 3 define four states. The thresholds 1 to 3 of the duration of error are obtained by calculation using the durations of errors and the link states of communication paths in the past, and is merely an example and not limited thereto.

In a case where the duration of error is less than the threshold 1 (1 ns), it is indicated that the communication path is in a link state in which high quality communication is possible. This link state represents, for example, a state in which only additive white Gaussian noise (AWGN) is occurring. This link state represents a state in which high-quality communication is possible, and is referred to as the “first linkup state”.

In a case where the duration of error is within the range of the threshold 1 (1 ns) to the threshold 2 (50 ms), it is indicated that the communication path is in a link state in which packet loss occurs occasionally due to an error that is left out of the error correction. This link state may be caused by, for example, scintillation, raindrop, snowflake, and the like. The link state is a state in which communication is possible depending on the application used, as will be described later, and is referred to as the “second linkup state”.

In a case where the duration of error is within the range of the threshold 2 (50 ms) to the threshold 3 (500 ms), it is indicated that the communication path is in a link state in which packet loss occurs in a burst occasionally. This link state may be caused by, for example, swaying due to strong winds, blocking objects, fog, and the like. This link state is a state in which communication is possible depending on the application used, as will be described later, and is referred to as the “third linkup state”.

In a case where the duration of error is greater than the threshold 3 (500 ms), it is indicated that the communication path is in a link state in which it is impossible to perform communication. This link state may be caused by, for example, blocking objects, fog, or the like. This link state is a state in which it is impossible to perform communication, and is referred to as the “linkdown state”.

The notification section 13 is configured to provide notification of information related to the link state. For example, the notification section 13 may notify a terminal apparatus connected to the communication apparatus 1 of information related to the link state of the communication path. This enables the terminal apparatus to select the communication path.

### Example Advantages of Communication Apparatus 1

As described in the foregoing, in the communication apparatus 1, the inference section 12 infers the link state of the communication path based at least on the duration of the error. Therefore, it becomes possible to infer the link state of the communication path and suitably react to the link state. In addition, the notification section 13 notifies a terminal apparatus or the like connected to the communication apparatus 1 of information related to the link state. This enables the terminal apparatus to select the communication path.

### (Flow of Communication Method)

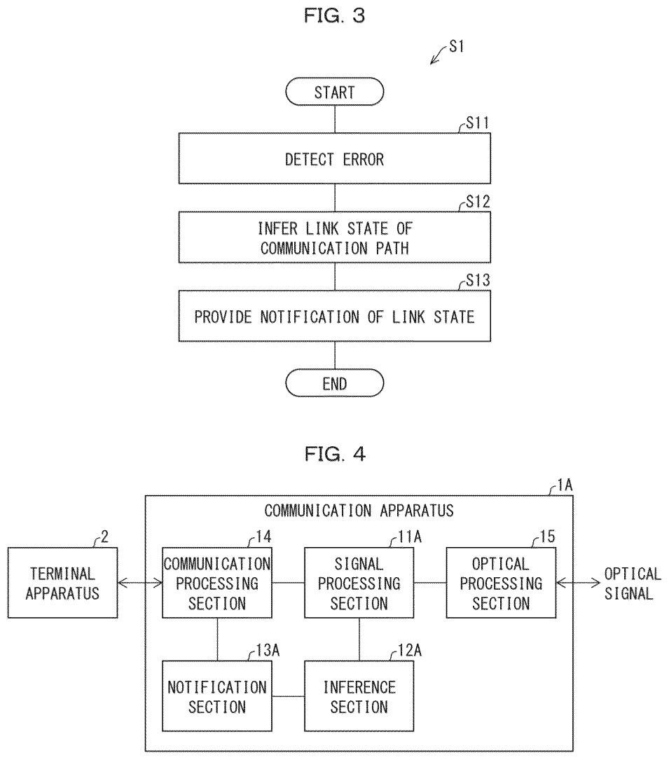

The following description will discuss the flow of a communication method S1 with reference to FIG. 3. FIG. 3 is a flowchart illustrating the flow of the communication method S1. The communication method S1 includes processes S11 to S13 as illustrated in FIG. 3.

First, the signal processing section 11 detects an error by subjecting a signal received by communication to signal processing (S11). For example, in a case where communication is performed by free space optical communication, the signal processing section 11 subjects an optical signal received via an optical sensor or the like to signal processing. For example, although the signal processing section 11 performs error detection and error correction of received data by using FEC, packet loss may occur if an error cannot be corrected by FEC. The signal processing section 11 detects, as an error, received data which cannot be corrected by the error correction.

Next, the inference section 12 infers the link state of a communication path based at least on the duration of the error (S12). The inference section 12, for example, determines which state of a plurality of states the link state is, based on the duration of the error. For example, the inference section 12 may determine which state of the first linkup state, the second linkup state, the third linkup state, and the linkdown state, described above, the link state of the communication path is.

Finally, the notification section 13 provides notification of information related to the link state (S13). For example, the notification section 13 may notify a terminal apparatus connected to the communication apparatus 1 of information related to the link state of the communication path. This enables the terminal apparatus to select the communication path.

### Example Advantages of Communication Method

As described in the foregoing, in the communication method S1, the inference section 12 infers the link state of the communication path based at least on the duration of the error. Therefore, it becomes possible to infer the link state of the communication path and suitably react to the link state. In addition, the notification section 13 notifies a terminal apparatus or the like connected to the communication apparatus 1 of information related to the link state. This enables the terminal apparatus to select the communication path.

### Second Example Embodiment

A second example embodiment, which is an example of the embodiment of the present invention, will be described in detail with reference to the drawings. The same reference symbols are given to constituent elements which have functions identical to those described in the above example embodiment, and descriptions as to such constituent elements are omitted as appropriate. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means illustrated in each drawing referred to for discussing the present example embodiment can be employed also in another example embodiment included in the present disclosure, provided that no particular technical problems occur.

### (Configuration of Communication Apparatus 1A)

The following description will discuss the configuration of a communication apparatus 1A with reference to FIG. 4. FIG. 4 is a block diagram illustrating the configuration of the communication apparatus 1A. Although the case where the communication apparatus 1A is an apparatus that performs free space optical communication will be described, the communication apparatus 1A may be, for example, an apparatus that utilizes radio waves. The communication apparatus 1A includes a signal processing section 11A, an inference section 12A, a notification section 13A, a communication processing section 14, and an optical processing section 15.

The communication processing section 14, which is communicatively connected to a terminal apparatus 2 by wired or wireless communication, receives data sent from the terminal apparatus 2 and outputs the received sent data to the signal processing section 11A. Further, the communication processing section 14 receives information related to the link state of a communication path from the notification section 13A and sends the information related to the link state to the terminal apparatus 2. The communication processing section 14 also sends received data outputted from the signal processing section 11A to the terminal apparatus 2.

The information related to the link state may indicate the link state of the communication path as it is, or may indicate an application type capable of communicating in the link state at that time. The information related to the link state may be an effective bandwidth of the communication path.

The signal processing section 11A is configured to subject the sent data received from the communication processing section 14 to signal processing, to modulate the sent data and output the modulated sent data to the optical processing section 15. Further, the signal processing section 11A is configured to subject, to signal processing, the received data converted into an electric signal by the optical processing section 15, to demodulate the received data and to output the demodulated received data to the communication processing section 14.

Although the signal processing section 11A performs error detection and error correction of received data by using FEC or the like in the signal processing of the received data, packet loss may occur if an error cannot be corrected by FEC. The signal processing section 11A detects, as an error, received data which cannot be corrected by error correction.

The optical processing section 15 converts the modulated sent data received from the signal processing section 11A, from an electric signal to an optical signal, and then outputs the optical signal to an opposite communication apparatus. Further, the optical processing section 15 receives data of the optical signal outputted from the opposite communication apparatus and converts the received data into an electric signal, and then the optical processing section 15 outputs the received data of the electric signal to the signal processing section 11A. That is, the optical processing section 15 converts an optical signal received by the free space optical communication into an electric signal.

The inference section 12A is configured to infer the link state of the communication path based on the duration of the error and the frequency of the error. For example, the inference section 12A may determine which state of a plurality of states the link state is, based on the duration of the error and the frequency of the error.

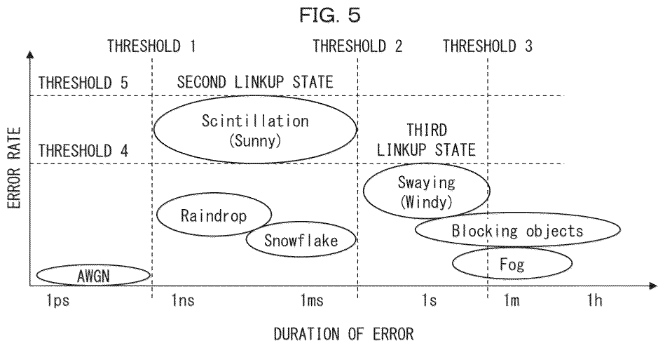

FIG. 5 is a diagram for describing an inference method of the link state. In FIG. 5, the horizontal axis represents the duration of error and the vertical axis represents the frequency of error (error rate). Based on thresholds 1 to 3 of the duration of error and thresholds 4 and 5 of the error rate, it is primarily determined whether the link state is the second linkup state or the third linkup state. It should be noted that the thresholds of the duration of error and the frequency of error are merely examples and are not limited thereto.

In a case where the duration of error is within the range of the threshold 1 (1 ns) to the threshold 2 (50 ms) and the error rate is within the range of the threshold 4 to the threshold 5, it is indicated that the communication path is in a link state in which packet loss occurs occasionally due to an error that is left out of error correction. This link state may be caused by, for example, scintillation. This link state is a state in which communication is possible depending on the application used, as will be described later, and is referred to as the “second linkup state”.

In a case where the duration of error is within the range of the threshold 2 (50 ms) to the threshold 3 (500 ms) and the error rate is not more than the threshold 4, it is indicated that the communication path is in a link state in which packet loss occurs in a burst occasionally. This link state may be caused by, for example, swaying due to strong winds and the like. This link state is a state in which communication is possible depending on the application used, as will be described later, and is referred to as the “third linkup state”.

The notification section 13A is configured to notify the terminal apparatus 2 of the information related to the link state via the communication processing section 14. For example, the notification section 13A may notify the terminal apparatus 2 connected to the communication apparatus 1 of the information related to the link state of the communication path. This enables the terminal apparatus 2 to select the communication path.

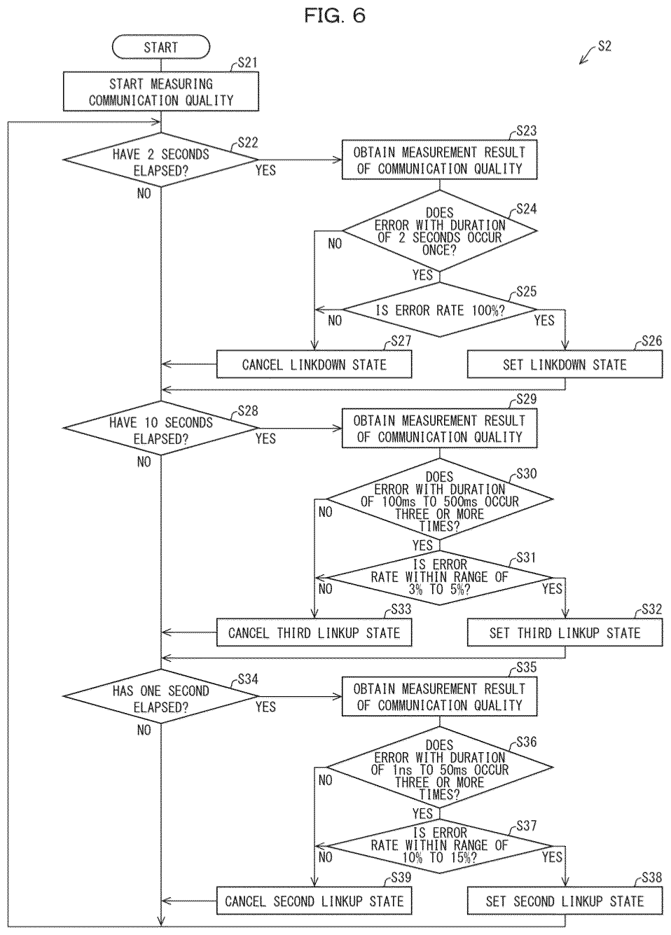

FIG. 6 is a flowchart for describing process procedures of the inference section 12A. First, the inference section 12A starts measuring the communication quality (S21). More specifically, based on an error detected by the signal processing section 11A, the inference section 12A carries out continuous calculation of the duration of the error and the frequency of the error (error rate), to set the calculation result to the measurement result of the communication quality. The inference section 12A also includes a timer and executes a process of each step in accordance with an elapsed time measured with the timer.

The inference section 12A determines whether or not the timer indicates that 2 seconds have elapsed (S22). Every time the timer indicates a lapse of 2 seconds, processes of steps S23 to S27 are carried out. If the timer indicates that 2 seconds have elapsed (S22, Yes), the inference section 12A obtains the communication quality measurement result of the last 2 seconds (S23) and determines whether or not an error with a duration of 2 seconds has occurred once (S24).

If no error with a duration of 2 seconds has occurred (S24, No), the operation proceeds to step S27. If an error with a duration of 2 seconds has occurred once (S24, Yes), the inference section 12A determines whether or not the error rate is 100% (S25). If the error rate is not 100% (S25, No), the operation proceeds to step S27.

If the error rate is 100% (S25, Yes), the inference section 12A sets the link state of the communication path to the linkdown state (S26), and the operation proceeds to step S28. In step S27, inferring that the link state of the communication path is not the linkdown state, the inference section 12A cancels the linkdown state, and the operation proceeds to step S28. Further, in step S22, if the timer indicates that 2 seconds have not elapsed (S22, No), the operation proceeds to step S28.

In step S28, the inference section 12A determines whether or not the timer indicates that 10 seconds have elapsed. Every time the timer indicates a lapse of 10 seconds, processes of steps S29 to S33 are carried out. If the timer indicates that 10 seconds have elapsed (S28, Yes), the inference section 12A obtains the communication quality measurement result of the last 10 seconds (S29) and determines whether or not an error with a duration of 100 ms to 500 ms has occurred three or more times (S30).

If an error with a duration of 100 ms to 500 ms has not occurred three or more times (S30, No), the operation proceeds to step S33. If an error with a duration of 100 ms to 500 ms has occurred three or more times (S30, Yes), the inference section 12A determines whether or not the error rate is within a range of 3% to 5% (S31). If the error rate is not within the range of 3% to 5% (S31, No), the operation proceeds to step S33.

If the error rate is within the range of 3% to 5% (S31, Yes), the inference section 12A sets the link state of the communication path to the third linkup state (S32), and the operation proceeds to step S34. In step S33, inferring that the link state of the communication path is not the third linkup state, the inference section 12A cancels the third linkup state, and the operation proceeds to step S34. In step S28, if the timer indicate that 10 seconds have not elapsed (S28, No), the operation proceeds to step S34.

In step S34, the inference section 12A determines whether or not the timer indicates that 1 second has elapsed. Every time the timer indicates a lapse of 1 second, processes of steps S35 to S39 are carried out. If the timer indicates that 1 second has elapsed (S34, Yes), the inference section 12A obtains the communication quality measurement result of the last 1 second (S35) and determines whether or not an error with a duration of 1 ns to 50 ms has occurred three or more times (S36).

If an error with a duration of 1 ns to 50 ms has not occurred three or more times (S36, No), the operation proceeds to step S39. If an error with a duration of 1 ns to 50 ms has occurred three or more times (S36, Yes), the inference section 12A determines whether or not the error rate is within a range of 10% to 15% (S37). If the error rate is not within the range of 10% to 15% (S37, No), the operation proceeds to step S39.

If the error rate is within the range of 10% to 15% (S37, Yes), the inference section 12A sets the link state of the communication path to the second linkup state (S38), and then, the operation returns to step S22 and the subsequent processes are repeated. In step S39, inferring that the link state of the communication path is not the second linkup state, the inference section 12A cancels the second linkup state, and then, the operation returns to step S22 and the subsequent processes are repeated. Further, in step S34, if the timer indicates that 1 second has not elapsed (S34, No), the operation returns to step S22 and the subsequent processes are repeated.

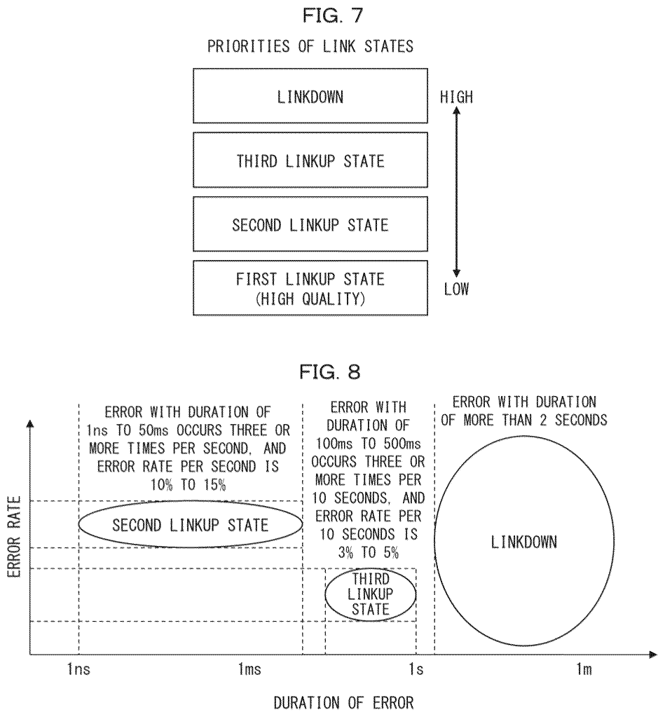

FIG. 7 is a diagram for describing the priorities of the link states. As illustrated in FIG. 7, the linkdown state has the highest priority and the first linkup state has the lowest priority. The inference section 12A sets the link state according to the flowchart illustrated in FIG. 6. The inference section 12A may set a plurality of link states in some cases. In such a case, from among the plurality of link states set, the inference section 12A employs a link state having the highest priority referring to FIG. 7.

The inference section 12A may set, to an effective bandwidth for communication, a value obtained by subtracting, from a bandwidth in a case where no interference occurs, a value obtained by multiplying the duration of the error and the frequency of the error, and the notification section 13A may notify the terminal apparatus 2 of the effective bandwidth.

Assuming that the bandwidth of the communication path in a case where no interference occurs is Bₗᵢₙₖ, the frequency of error of the communication path is Pₓ, and the duration of error of the communication path is Dₓ, the effective bandwidth EBₓ of the communication path can be expressed by the following equation (Equation 1). Since the effective bandwidth is a time available for use by the application, the effective bandwidth may also be referred to as the available time.

EBₓ=Bₗᵢₙₖ−Pₓ×Dₓ (Equation 1)

FIG. 8 is a diagram illustrating the link states inferred based on the flow illustrated in FIG. 6. In FIG. 8, the horizontal axis represents the duration of error and the vertical axis represents the frequency of error (error rate). The second linkup state is a state in which an error with a duration of 1 ns to 50 ms occurs three or more times per second, and an error rate per second is 10% to 15%.

The third linkup state is a state in which an error with a duration of 100 ms to 500 ms occurs three or more times per 10 seconds, and an error rate per 10 seconds is 3% to 5%. The linkdown state is a state in which an error with a duration of more than 2 seconds occurs. If these states are detected, it is highly likely that the same state continues. Thus, communication with an application depending on the link state is carried out.

The inference section 12A may infer the suitability of the communication path for use by an application configured to utilize communication based on the type of the application and the link state. The notification section 13A notifies the terminal apparatus 2 of the inferred suitability of the communication path for use by the application, which is inferred by the inference section 12A.

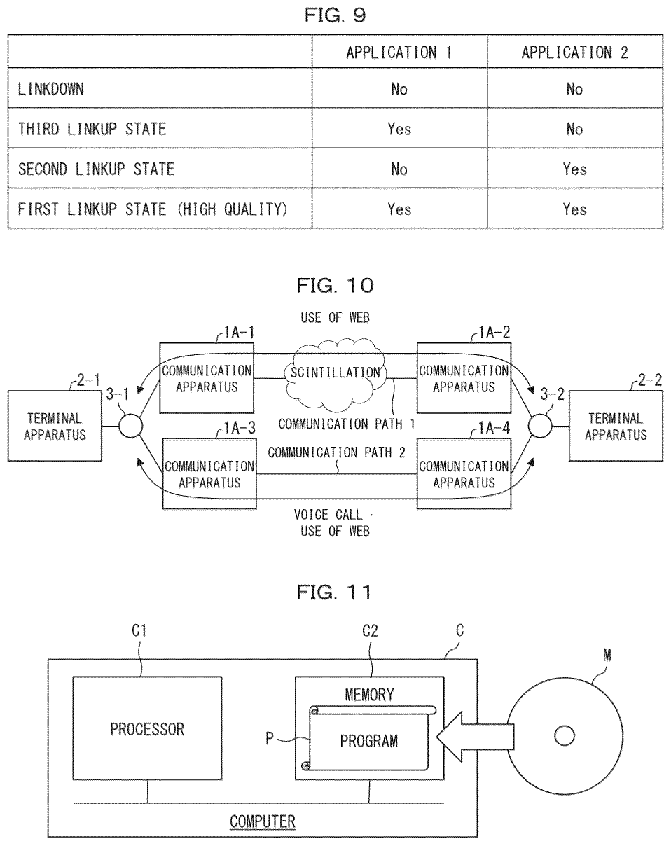

FIG. 9 is a table illustrating correspondence between link states and application types. An application 1 is an application capable of suitably communicating via a communication path in the first linkup state (high quality) and via a communication path in the third linkup state. The application 1 may be, for example, an application capable of communicating even in a state in which packet lost occurs in a burst, such as in file transmission. It is assumed that although the application 1 is capable of communicating even in a case where the communication path is in the second linkup state, another application 2 has precedence thereover.

The application 2 is an application capable of suitably communicating via a communication path in the first linkup state (high quality) and via a communication path in the second linkup state. The application 2 may be, for example, an application capable of communicating even in a state where packet loss occurs occasionally, such as use of the Web. Applications that cannot communicate in a degraded quality state, such as voice or streaming, use a communication path in the first linkup state (high quality). If a communication path is in the linkdown state, no application can use the communication path.

FIG. 10 is a diagram for describing switching of communication paths. FIG. 10 depicts a communication path 1 that is a communication path between a communication apparatus 1A-1 and a communication apparatus 1A-2, and a communication path 2 that is a communication path between a communication apparatus 1A-3 and a communication apparatus 1A-4.

If it is inferred that the communication path 1 is in the second linkup state and the communication path 2 is in the first linkup state, terminal apparatuses 2-1 and 2-2 use the communication path 1 for use by an application for browsing the Web and do not use the communication path 1 for use by an application of a voice call, a streaming, or the like.

The terminal apparatuses 2-1 and 2-2 use the communication path 2 for use by applications of voice call, streaming, web browsing, and the like. The terminal apparatuses 2-1 and 2-2 appropriately switch the path selection switches 3-1 and 3-2 to select a communication path to be used for each application.

### Example Advantages of Communication Apparatus 1A

As described in the foregoing, in the communication apparatus 1A, the inference section 12A infers the link state of the communication path based on the duration of error and the frequency of the error. Therefore, it is possible to more accurately infer the link state of the communication path, and this makes it possible to suitably react to the link state.

Further, in the communication apparatus 1A, the inference section 12A sets, to the effective bandwidth for communication, a value obtained by subtracting, from a bandwidth in a case where no interference occurs, a value obtained by multiplying the duration of the error and the frequency of the error, and the notification section 13A notifies the terminal apparatus 2 of the effective bandwidth. This enables the terminal apparatus 2 to suitably select the communication path.

In the communication apparatus 1A, the inference section 12A infers the suitability of the communication path for use by an application configured to utilize communication based on the type of the application and the link state. This enables the terminal apparatus 2 to suitably select the communication path depending on the application used.

In the communication apparatus 1A, the optical processing section 15 is configured to convert an optical signal received by free space optical communication into an electric signal, and the signal processing section 11A is configured to detect an error by subjecting the electric signal to signal processing. This enables the terminal apparatus 2 to suitably select the communication path in free space optical communication.

### Software Implementation Example

The functions of part of or all of the communication apparatuses 1, and 1A can be realized by hardware such as an integrated circuit (IC chip) or can be alternatively realized by software.

In the latter case, the communication apparatuses 1 and 1A are implemented by, for example, a computer that executes instructions of a program that is software implementing the foregoing functions. FIG. 11 illustrates an example of such a computer (hereinafter, referred to as “computer C”). FIG. 11 is a block diagram illustrating the hardware configuration of the computer C that functions as the communication apparatuses 1 and 1A.

The computer C includes at least one processor C1 and at least one memory C2. The memory C2 stores a program P for causing the computer C to function as the abovementioned apparatuses. The processor C1 of the computer C retrieves the program P from the memory C2 and executes the program P, so that the functions of the abovementioned communication apparatuses 1 and 1A are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input/output interface for connecting the computer C to an input/output apparatus(es) such as a keyboard, a mouse, a display and/or a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### [Additional Remark 1]

The present disclosure includes techniques described in supplementary notes below. Note, however, that the present invention is not limited to the techniques described in supplementary notes below, but may be altered in various ways within the scope of the claims.

### (Supplementary Note 1)

A communication apparatus includes:
signal processing means for detecting an error by subjecting a signal received by communication to signal processing;
inference means for inferring a link state of a communication path based at least on duration of the error; and
notification means for providing notification of information related to the link state.

### (Supplementary Note 2)

The communication apparatus according to Supplementary note 1, wherein the inference means infers the link state of the communication path based on the duration of the error and frequency of the error.

### (Supplementary Note 3)

The communication apparatus according to Supplementary note 2, wherein
the inference means sets, to an effective bandwidth for the communication, a value obtained by subtracting, from a bandwidth in a case where no interference occurs, a value obtained by multiplying the duration of the error and the frequency of the error, and
the notification means provides notification of the effective bandwidth.

### (Supplementary Note 4)

The communication apparatus according to any one of Supplementary notes 1 to 3, wherein the inference means infers suitability of the communication path for use by an application configured to utilize communication based on a type of the application and the link state.

### (Supplementary Note 5)

The communication apparatus according to any one of Supplementary notes 1 to 4, wherein
the communication is free space optical communication,
the communication apparatus further includes optical processing for converting an optical signal received by the free space optical communication into an electric signal, and
the signal processing means detects the error by subjecting the electric signal to signal processing.

### (Supplementary Note 6)

A communication method including:
detecting an error by subjecting a signal received by communication to signal processing;
inferring a link state of a communication path based at least on duration of the error; and
providing notification of information related to the link state.

### (Supplementary Note 7)

The communication method according to Supplementary note 6, wherein in the inferring, the link state of the communication path is inferred based on the duration of the error and frequency of the error.

### (Supplementary Note 8)

The communication method according to Supplementary note 7, wherein
in the inferring, a value is set to an effective bandwidth for the communication, the value being obtained by subtracting, from a bandwidth in a case where no interference occurs, a value obtained by multiplying the duration of the error and the frequency of the error, and
in the providing of notification, notification of the effective bandwidth is provided.

### (Supplementary Note 9)

The communication method according to any one of Supplementary notes 6 to 8, wherein in the inferring, suitability of the communication path for use by an application configured to utilize the communication is inferred based on a type of the application and the link state.

### (Supplementary Note 10)

The communication method according to any one of Supplementary notes 6 to 9, wherein
the communication is free space optical communication,
the method further includes converting an optical signal received by the free space optical communication into an electric signal, and
in the detecting of the error, the error is detected by subjecting the electric signal to signal processing.

### (Supplementary Note 11)

A control program for causing a computer to operate as the communication apparatus according to any one of Supplementary notes 1 to 5, the control program causing the computer to function as each of the means.

### REFERENCE SIGNS LIST

1, 1A Communication apparatus
2 Terminal apparatus
11, 11A Signal processing section
12, 12A Inference section
13, 13A Notification section
14 Communication processing section
15 Optical processing section

1. A communication apparatus comprising at least one processor, the at least one processor carrying out:
a process of detecting an error by subjecting a signal received by communication to signal processing;
a process of inferring a link state of communication path based at least on duration of the error; and
a process of providing notification of information related to the link state.

2. The communication apparatus according to claim 1, wherein in the inferring process, the at least one processor infers the link state of the communication path based on the duration of the error and frequency of the error.

3. The communication apparatus according to claim 2, wherein
in the inferring process, the at least one processor sets, to an effective bandwidth for the communication, a value obtained by subtracting, from a bandwidth in a case where no interference occurs, a value obtained by multiplying the duration of the error and the frequency of the error, and
in the notification providing process, the at least one processor provides notification of the effective bandwidth.

4. The communication apparatus according to claim 1, wherein in the inferring process, the at least one processor infers suitability of the communication path for use by an application configured to utilize communication based on a type of the application and the link state.

5. The communication apparatus according to claim 1, wherein
the communication is free space optical communication,
the at least one processor further carries out a process of converting an optical signal received by the free space optical communication into an electric signal, and
in the error detecting process, the at least one processor detects the error by subjecting the electric signal to signal processing.

6. A communication method comprising:
detecting an error by subjecting a signal received by communication to signal processing;
inferring a link state of a communication path based at least on duration of the error; and
providing notification of information related to the link state.

7. The communication method according to claim 6, wherein in the inferring, the link state of the communication path is inferred based on the duration of the error and frequency of the error.

8. The communication method according to claim 7, wherein in the inferring, a value is set to an effective bandwidth for the communication, the value being obtained by subtracting, from a bandwidth in a case where no interference occurs, a value obtained by multiplying the duration of the error and the frequency of the error, and
in the providing of notification, notification of the effective bandwidth is provided.

9. The communication method according to claim 6, wherein in the inferring, suitability of the communication path for use by an application configured to utilize the communication is inferred based on a type of the application and the link state.

10. The communication method according to claim 6, wherein
the communication is free space optical communication,
the method further comprises converting an optical signal received by the free space optical communication into an electric signal, and
in the detecting of the error, the error is detected by subjecting the electric signal to signal processing.

11. A non-transitory storage medium that stores a program for causing a computer to carry out:
a process of detecting an error by subjecting a signal received by communication to signal processing;
a process of inferring a link state of a communication path based at least on duration of the error; and
a process of providing notification of information related to the link state.

12. The non-transitory storage medium according to claim 11, wherein in the inferring process, the link state of the communication path is inferred based on the duration of the error and frequency of the error.

13. The non-transitory storage medium according to claim 12, wherein
in the inferring process, a value obtained by subtracting, from a bandwidth in a case where no interference occurs, a value obtained by multiplying the duration of the error and the frequency of the error, is set to an effective bandwidth for the communication, and
in the notification providing process, notification of the effective bandwidth is provided.

14. The non-transitory storage medium according to claim 11, wherein in the inferring process, suitability of the communication path for use by an application configured to utilize the communication is inferred based on a type of the application and the link state.

15. The non-transitory storage medium according to claim 11, wherein
the communication is free space optical communication,
the program further causes the computer to carry out a process of converting an optical signal received by the free space optical communication into an electric signal, and
in the error detecting process, the error is detected by subjecting the electric signal to signal processing.
